(19) United States
(12) Patent Application Publication
(10) Pub. No.: US 2021/0278376 A1
(43) Pub. Date: Sep. 9, 2021

(54) ACOUSTIC EMISSION PROBE POSITIONING SYSTEM, TEST BLOCK FOR SYSTEM, AND APPLICATION OF SYSTEM

(71) Applicants: SICHUAN UNIVERSITY, Chengdu (CN); YALONG RIVER HYDROPOWER DEVELOPMENT COMPANY, LTD., Chengdu (CN)

(72) Inventors: Ru ZHANG, Chengdu (CN); Zetian Zhang, Chengdu (CN); Shiyong WU, Chengdu (CN); Li REN, Chengdu (CN); Jifang ZHOU, Chengdu (CN); Mingzhong GAO, Chengdu (CN); Chengbo DU, Chengdu (CN); Chaopeng ZHANG, Chengdu (CN); Ting AI, Chengdu (CN); Yang LIU, Chengdu (CN); Xiaopeng LI, Chengdu (CN); Li QIN, Chengdu (CN)

(21) Appl. No.: 17/326,330

(22) Filed: May 21, 2021

Related U.S. Application Data
(63) Continuation of application No. PCT/CN2019/092317, filed on Jun. 21, 2019.

(30) Foreign Application Priority Data
Jun. 19, 2019 (CN) 201910533629.5

(51) Int. Cl. G01N 29/14; G01N 3/24; G01N 3/08

(52) U.S. Cl. CPC G01N 29/14; G01N 2203/0658; G01N 3/08; G01N 3/24

(57) ABSTRACT

An acoustic emission probe positioning system, a test block for the system, and an application of the system are disclosed. The positioning system comprises a first test block and a second test block that are oppositely arranged and that define a non-closed test region. The first test block includes a first main portion and a first protruding portion that are connected to each other. The second test block includes a second main portion and a second protruding portion that are connected to each other. The first main portion and the second main portion are vertically opposite to each other, and the first protruding portion and the second protruding portion are opposite to each other left and right in a staggered manner. Multiple first probe storage holes are defined in the first main portion, and multiple second probe storage holes are defined in the first protruding portion. Multiple third probe storage holes are defined in the second main portion, and multiple fourth probe storage holes are defined in the second protruding portion. The first probe storage holes, the second probe storage holes, the third probe storage holes, and the fourth probe storage holes are each used for accommodating an acoustic emission probe.

### CROSS-REFERENCE TO RELATED APPLICATIONS

This application is a continuation of co-pending International Patent Application No. PCT/CN2019/092317, filed on Jun. 21, 2019, which claims the priority and benefit of Chinese patent application number 201910533629.5, filed Jun. 19, 2019 with China National Intellectual Property Administration, the entire contents of which are incorporated herein by reference.

### BACKGROUND OF THE DISCLOSURE

### 1. Technical Field

The disclosure relates to the technical field of positioning devices, in particular to an acoustic emission probe positioning system, a test block for the system, and an application of the system.

### 2. Description of Related Art

During an acoustic emission test, the installation and arrangement of acoustic emission probes have great influence on the acquisition of acoustic emission signals. As for the installation of the acoustic emission probes, the installation positions of the acoustic emission probes on the surface of a specimen are generally determined by markings, and then Vaseline is uniformly smeared on the surfaces of the probes, such that the acoustic emission probes can be bonded at the marked positions on the surface of the specimen by means of the bonding force of the Vaseline. Although the acoustic emission probes can be accurately and asymmetrically disposed at preset positions and can be bonded on the surface of the specimen in this way, the operation is complicated, the acoustic emission probes bonded with the Vaseline are infirm, and stable contact between the probes and the surface of the specimen cannot be ensured. Moreover, the asymmetric arrangement points need to be determined by measurement every time, and there may be great deviations between marked positions and positions preset on acoustic emission test software. In addition, the probes bonded in this way will be inevitably exposed out of the surface of the specimen, and the surface of the specimen will be shielded to some extent by the probes and connecting wires. So, when different tests are carried out synchronously, the exposed acoustic emission probes and connecting wires may cause interference to other tests. For example, in case where the acoustic emission test and the DIC test are carried out synchronously, the acoustic emission probes disposed on the surface of the specimen will cause severe interference on the displacement of speckles, captured by a camera, on the surface of the specimen.

During the uniaxial compression test, the probes are arranged on left and right sides of a specimen ensure that the development of a fracture in the front side of the specimen can be observed without being affected by the probes. However, as for the direct shear test, there is no yet a solution that can avoid the interference on the observation of the surface of the specimen and can realize an asymmetric arrangement of the acoustic emission probes. Thus, under the precondition that the acoustic emission probes can be easily arranged, it is necessary to develop an acoustic probe arrangement device to realize a stable and asymmetric arrangement of the acoustic emission probes on the surface of a specimen without affecting displacement monitoring of DIC speckles carried out at the same time during the direct shear test.

### BRIEF SUMMARY OF THE DISCLOSURE

The objective of the disclosure is to provide an acoustic emission probe positioning system, a test block for the system, and an application of the system to facilitate the installation and arrangement of acoustic emission probes during a direct shear test and a uniaxial compression test.

A first technical solution of the disclosure is as follows:

An acoustic emission probe positioning system comprises a first test block and a second test block which are arranged oppositely, wherein a non-closed test region is defined by the first test block and the second test block, the first test block comprises a first main portion and a first protruding portion which are connected to each other, the second test block comprises a second main portion and a second protruding portion which are connected to each other, the first main portion and the second main portion are vertically opposite to each other, and the first protruding portion and the second protruding portion are s are opposite to each other left and right in a staggered manner;

A plurality of first probe storage holes are formed in a side, opposite to the second main portion, of the first main portion, and a plurality of second probe storage holes are formed in a side, opposite to the second protruding portion, of the first protruding portion;

A plurality of third probe storage holes are formed in a side, opposite to the first main portion, of the second main portion, and a plurality of fourth probe storage holes are formed in a side, opposite to the first protruding portion, of the second protruding portion;

The first probe storage holes, the second probe storage holes, the third probe storage holes and the fourth probe storage holes are all used for accommodating acoustic emission probes.

According to a further specific solution, when the first test block and the second test block are used, projections of the plurality of first probe storage holes and the plurality of third probe storage holes in an X-axis direction do not overlap, and projections of the plurality of second probe storage holes and the plurality of fourth probe storage holes in a Y-direction do not overlap.

According to a further specific solution, four first probe storage holes are formed in the first main portion and are distributed in the first main portion in a parallelogram shape.

According to a further specific solution, two second probe storage holes are formed in the first protruding portion, and there are a height difference in a vertical direction and a distance difference in a horizontal direction between the two second probe storage holes in the first protruding portion.

According to a further specific solution, an upper side of the first protruding portion and a lower side of the second protruding portion are located on the same horizontal plane.

According to a further specific solution, elastic components and connecting gaskets are arranged in the first probe storage holes, the second probe storage holes, the third probe storage holes and the fourth probe storage holes, the elastic components are connected to the connecting gaskets, and the connecting gaskets are connected to the acoustic emission probes.

According to a further specific solution, the first probe storage holes, the second probe storage holes, the third probe storage holes and the fourth probe storage holes are communicated with wiring ducts which are used for connecting wires, connected to the acoustic emission probes, to an amplifier outside the test blocks.

A second technical solution of the disclosure is as follows:

A test block for an acoustic emission probe positioning system comprises a main portion and a protruding part which are connected to each other, wherein a plurality of first probe storage holes are formed in the main portion, a plurality of second probe storage holes are formed in the protruding part, and the first probe storage holes and the second probe storage holes are all used for accommodating acoustic emission probes; and projections of the plurality of first probe storage holes in an X-axis direction do not overlap, and projections of the second probe storage holes in a Y-axis direction do not overlap.

A third technical solution of the disclosure is as follows:

An application of an acoustic emission probe positioning system is provided. The acoustic emission probe positioning system is applied to a direct shear test and/or a uniaxial compression test.

The disclosure has at least one of the following beneficial effects:

1. Acoustic emission probes are installed in the first probe storage holes, the second probe storage holes, the third probe storage holes and the fourth probe storage holes, then a tested specimen is placed in the test region, the operation is convenient and easy, and the inconvenience and instability of asymmetric installation of the acoustic emission probes can be overcome;

2. When installed, the acoustic emission probes are connected to the connecting gaskets to be prevented from falling and can be installed more easily;

3. The acoustic emission probes can be ejected by springs to abut against the surface of the tested specimen, such that close contact between the acoustic emission probes and end faces of the tested specimen is ensured;

4. The wiring ducts are used for accommodating wires connected to the acoustic emission probes, such that the surface of the tested specimen can be monitored during other tested without being affected by the wires.

### BRIEF DESCRIPTION OF THE SEVERAL VIEWS OF THE DRAWINGS

To more clearly explain the technical solutions of the embodiments of the disclosure, drawings used in the embodiments will be briefly introduced below. It should be understood that the following drawings merely illustrate some embodiments of the disclosure, and thus should not be construed as limitations of the scope of the disclosure. Those ordinarily skilled in the art can obtain other relating drawings according to the following ones without creative labor.

FIG. 1 is a structural diagram of an acoustic emission probe positioning system according to the disclosure;

FIG. 2 is a front view of FIG. 1;

FIG. 3 is a structural diagram of a test block for the acoustic emission probe positioning system according to the disclosure;

FIG. 4 is a connection diagram of an elastic component and a connecting gasket in a first probe storage hole according to the disclosure.

### REFERENCE SIGNS

1, first test block; 2, second test block; 3, test region; 4, first main portion; 5, first protruding portion; 6, second main portion; 7, second protruding portion; 8, first probe storage hole; 9, second probe storage hole; 10, elastic component; 11, connecting gasket; 12, wiring duct.

### DETAILED DESCRIPTION OF THE DISCLOSURE

To make the objectives, technical solutions and advantages of the embodiments of the disclosure clearer, the technical solutions of the embodiments of the disclosure will be clearly and completely described below in conjunction with the accompanying drawings of the embodiments. Obviously, the embodiments in the following description are merely illustrative ones, and are not all possible ones of the disclosure. Generally, the components in the embodiments of the disclosure described and illustrated in the drawings can be configured and designed in different manners.

It should also be noted that unless otherwise clearly specified and defined, terms involved in the description of the disclosure such as “arrange”, “install”, “connect” and “connection” should be broadly understood. For example, “connection” may refer to fixed connection or detachable connection; or direct connection, indirect connection by means of an intermediate medium, or internal communication of two elements. Those ordinarily skilled in the art can appreciate the specific meanings of these terms in the disclosure as the case may be.

### Embodiment 1

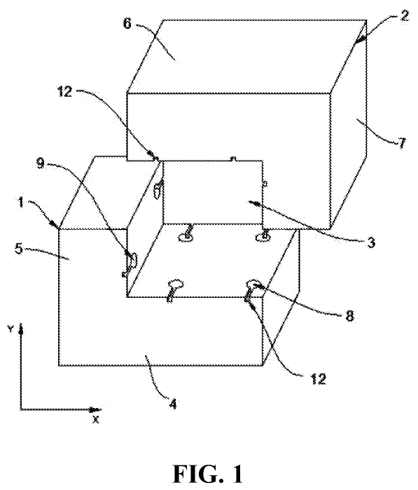

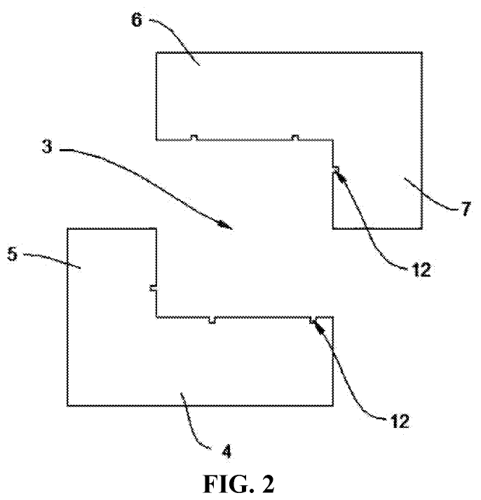

Referring to FIG. 1 and FIG. 2, this embodiment provides an acoustic emission probe positioning system, which comprises a first test block 1 and a second test block 2 which are arranged oppositely, wherein a non-closed test region 3 is defined by the first test block 1 and the second test block 2 and allows a tested specimen to be placed therein, the first test block 1 comprises a first main portion 4 and a first protruding portion 5 which are connected to each other, the first main portion 4 and the first protruding portion 5 are formed integrally, the second test block 2 comprises a second main portion 6 and a second protruding portion 7 which are connected to each other, the second main portion 6 and the second protruding portion 7 are formed integrally, the first main portion 4 and the second main portion 6 are vertically opposite to each other, and the first protruding portion 5 and the second protruding portion 7 are opposite to each other left and right in a staggered manner; a plurality of first probe storage holes 8 are formed in a side, opposite to the second main portion 6, of the first main portion 4, and a plurality of second probe storage holes 9 are formed in a side, opposite to the second protruding portion 7, of the first protruding portion 5; a plurality of third probe storage holes are formed in a side, opposite to the first main portion 4, of the second main portion 6, and a plurality of fourth probe storage holes are formed in a side, opposite to the first protruding portion 5, of the second protruding portion 7; the first probe storage holes 8, the second probe storage holes 9, the third probe storage holes and the fourth probe storage holes are all used for accommodating acoustic emission probes; and when the first test block 1 and the second test block 2 are used, projections of the plurality of first probe storage holes 9 and the plurality of third probe storage holes in an X-axis direction do not overlap, and projections of the plurality of second probe storage holes 9 and the plurality of fourth probe storage holes in a Y-axis direction do not overlap.

Four first probe storage holes 8 are formed in the first main portion 4 and are distributed in the first main portion 4 in a parallelogram shape; two second probe storage holes 9 are formed in the first protruding portion 5, and there are a height difference in a vertical direction and a distance difference in a horizontal direction between the two second probe storage holes 8 in the first protruding portion 5; the first test block 1 and the second test block 2 are identical in structure and are distributed in a central symmetry manner along the central axis of the test region 3, that is, the second test block 2 can be formed after the first test block 1 is rotated by 180° along the central axis of the test region 3; the third probe storage holes in the second main portion 6 are arranged in the same manner as the first probe storage holes 8 in the first main portion 4, and the fourth probe storage holes in the second protruding portion 6 are arranged in the same manner as the third probe storage holes in the first protruding portion 5.

The acoustic emission probe positioning system designed in such a manner is formed with the plurality of asymmetric first probe storage holes 8, the plurality of asymmetric second probe storage holes 9, the plurality of asymmetric third probe storage holes and the plurality of asymmetric fourth probe storage holes, the acoustic emission probes can be directly fixed in the first probe storage holes 8, the second probe storage holes 9, the third probe storage holes and the fourth probe storage holes separately, after the tested specimen is placed in the test region 3, an acoustic emission test can be carried out on end faces of the tested specimen directly by means of the acoustic emission probes in the first probe storage holes 8, the second probe storage holes 9, the third probe storage holes and the fourth probe storage holes, the operation is convenient and easy, and the inconvenience and instability of asymmetric installation of the acoustic emission probes can be overcome. When the acoustic emission test and a DIC test are carried out synchronously, the acoustic emission probes arranged on the surface of the tested specimen will not cause severe interference to the displacement of speckles, captured by a camera, on the surface of the specimen.

The first test block 1 and the second test block 2 are vertically opposite to each other, vertical projections of the first main portion 4 and the second main portion 6 are overlapped, and after the tested specimen is placed in the test region 3, a force can be vertically applied to the first main portion 4 and the second main portion 6 to carry out a uniaxial compression test; the first protruding portion 5 and the second protruding portion 7 are opposite to each other left and right in a staggered manner, that is, the first protruding portion 5 and the second protruding portion 7 are opposite to each other left and right and are staggered vertically, and in case where the first test block 1 is located below the second test block 2, as shown in FIG. 1, the upper side of the first protruding portion 5 and the lower side of the second protruding portion 7 are located on the same horizontal plane; and after the tested specimen is placed in the test region 3, a force can be horizontally applied to the first protruding portion 5 and the second protruding portion 7 to carry out a direct shear test.

Referring to FIG. 1, in the disclosure, four first probe storage holes 8 are formed in the first main portion 4 and are distributed in the first main portion 4 in a parallelogram shape, such that the four first probe storage holes 8 in the first test block 1 are asymmetrically distributed in the first main portion 4; the first test block 1 and the second test block 2 are identical in structure and are distributed in a central symmetry manner along the central axis of the test region 3, such that the eight acoustic emission probes on the first main portion 4 and the second main portion 6 can carry out acoustic emission detection on different and asymmetric positions of the tested specimen during a test, and the detection effect is better. Two second probe storage holes 9 are formed in the first protruding portion 5, and there is a height difference in a vertical direction and a distance difference in a horizontal direction between the two second probe storage holes 9 in the first protruding portion 5, that is, the two probe storage holes 9 in the first protruding portion 5 are staggered vertically and horizontally; the first test block 1 and the second test block 2 are identical in structure and are distributed in a central symmetry manner along the central axis of the test region 3, such that the four acoustic emission probes on the first protruding portion 5 and the second protruding portion 7 can carry out acoustic emission detection on different and asymmetric positions of the tested specimen during the test. In this way, an asymmetric arrangement of the acoustic emission probes on the surface of the tested specimen is realized during the test.

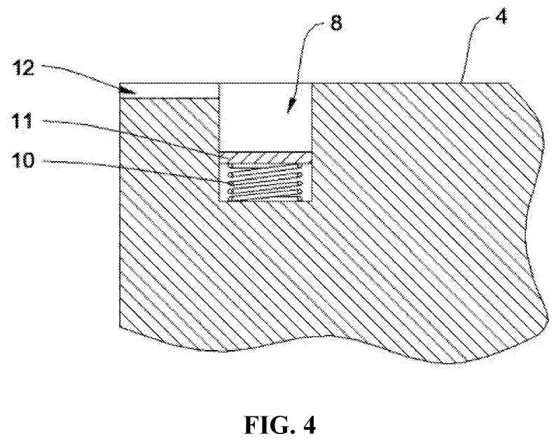

Referring to FIG. 4, elastic components 10 and connecting gaskets 11 are arranged in the first probe storage holes 8, the second probe storage holes 9, the third probe storage holes and the fourth probe storage holes respectively, one end of each elastic component 10 is connected to the bottom of one first probe storage hole 8, one second probe storage hole 9, one third probe storage hole or one fourth probe storage hole, the other end of each elastic component 10 is connected to one connecting gasket 11, and the connecting gaskets 11 are connected to the acoustic emission probes. Wherein, the connecting gaskets 11 are magnetic gaskets, such that the acoustic emission probes can be attracted by the connecting gaskets 11 to be prevented from falling, and the acoustic emission probes can be installed more easily and conveniently. The diameter of the first probe storage holes 8, the second probe storage holes 9, the third probe storage holes and the forth probe storage holes is slightly greater than that of the acoustic emission probes (the diameter of the acoustic emission probes is 7.91 mm), and the depth of the first probe storage holes 8, the second probe storage holes 9, the third probe storage holes and the fourth probe storage holes is greater than the height of the acoustic emission probes (the height of the acoustic emission probes is 7.3 mm), such that the acoustic emission probes can be smoothly disposed in the first probe storage holes 8, the second probe storage holes 9, the third probe storage holes and the fourth probe storage holes. The elastic components 10 and the connecting gaskets 11 are arranged in the first probe storage holes 8, the second probe storage holes 9, the third probe storage holes and the fourth probe storage holes, such that when the acoustic emission probes are disposed in the first probe storage holes 8, the second probe storage holes 9, the third probe storage holes or the fourth probe storage holes, test ends of the acoustic emission probes are located outside the first probe storage holes 8, the second probe storage holes 9, the third probe storage holes or the fourth probe storage holes; and after the elastic components 10 are compressed, the test ends of the acoustic emission probes can be located at openings of the first probe storage holes 8, the second probe storage holes 9, the third probe storage holes or the fourth probe storage holes. The elastic components 10 may be springs with a length of 2.0 mm or other elastic devices, and are welded in the first probe storage holes 8, the second probe storage holes 9, the third probe storage holes and the fourth probe storage holes. When installed in the first probe storage holes 8, the second probe storage holes 9, the third probe storage holes and the fourth probe storage holes, the acoustic emission probes will be attracted onto the connecting gaskets 11 and will be in close contact with end faces of the tested specimen under the effect of the elastic components 10, such that convenient, stable and reliable installation is realized.

The first probe storage holes 8, the second probe storage holes 9, the third probe storage holes and the fourth probe storage holes are communicated with wiring ducts 12 which are specifically used for connecting wires, connected to the acoustic emission probes, to an amplifier outside the test blocks, and by adoption of the wiring ducts 12, the surface of the tested specimen can be monitored during other tests without being affected by the wires.

In this embodiment, the test region 3 may be square, rectangular or round, and the shape of the first test block 1 and the second test block 2 can be changed according to the shape of different tested specimens to adapt to more specimens, wherein when a cylindrical specimen is tested, the first protruding portion 5 and the second protruding portion 7 are arc; the first main portion 4 and the second protruding portion 7 are arc; or, only the opposite sides of the first main portion 4 and the second protruding portion 7 are arc.

### Embodiment 2

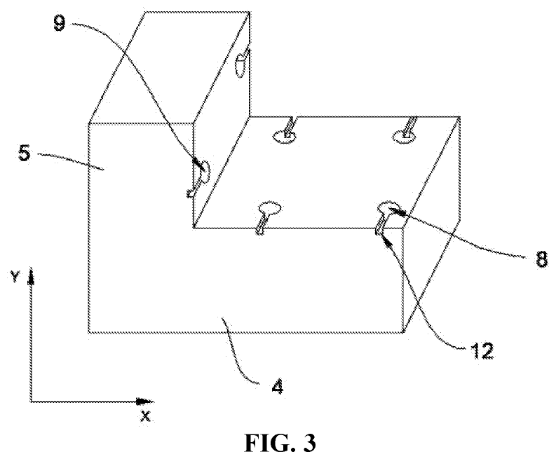

Referring to FIG. 3, this embodiment provides a test block for an acoustic emission probe positioning system. The test block comprises a main portion 4 and a protruding part 5 which are connected to each other, wherein a plurality of first probe storage holes 8 are formed in the main portion 4, a plurality of second probe storage holes 9 are formed in the protruding part 5, and the first probe storage holes 8 and the second probe storage holes 9 are all used for accommodating acoustic emission probes; and projections of the plurality of first probe storage holes 8 in an X-axis direction do not overlap, and projections of the plurality of second probe storage holes 9 in a Y-axis direction do not overlap. The acoustic emission probes are disposed in the first probe storage holes 8 and the second probe storage holes 9 to realize an asymmetric distribution.

Wherein, four first probe storage holes 8 are formed in the main portion 4 of the test block and are distributed in the main portion 4 in a parallelogram shape; and two second probe storage holes 9 are formed in the protruding part 5, and there is a height difference in a vertical direction and a distance difference in a horizontal distance between the two second probe storage holes 9 in the protruding part 5.

Elastic components 10 and connecting gaskets 11 are arranged in the first probe storage holes 8 and the second probe storage holes 9, one end of each elastic component 10 is connected to the bottom of one first probe storage hole 8 or one second probe storage hole 9, the other end of each elastic component 10 is connected to one connecting gasket 11, and the connecting gaskets 11 are connected to the acoustic emission probes.

The first probe storage holes 8 and the second probe storage holes 9 are communicated with wiring ducts 12 which are used for connecting wires, connected to the acoustic emission probes, to an amplifier outside the test block.

### Embodiment 3

This embodiment provides an application of an acoustic emission probe positioning system. The acoustic emission probe positioning system described in Embodiment 1 is applied to a direct shear test or a uniaxial compression test. The acoustic emission probe positioning system can be applied to one or both of the two tests.

During the uniaxial compression test, acoustic emission probes can be arranged on left and right sides of a tested specimen to avoid the influence of the acoustic emission probes on the observation of the development of a fracture in the front side of the specimen. During the direct shear test, acoustic emission probes can be stably and asymmetrically arranged on the surface of a tested specimen, and the displacement of DIC speckles can be monitored synchronously without being affected.

The aforesaid embodiments are merely typical ones of the disclosure, and are not intended to limit the disclosure. Different alterations and variations of the disclosure can be made by those skilled in the art. Any modifications, equivalent substitutions and improvements made based on the spirit and principle of the disclosure should also fall within the protection scope of the disclosure.

What is claimed is:

1. An acoustic emission probe positioning system, comprising a first test block and a second test block that are oppositely arranged, the first test block and the second test block defining a non-closed test region, wherein the first test block comprises a first main portion and a first protruding portion that are connected to each other, the second test block comprises a second main portion and a second protruding portion that are connected to each other, wherein the first main portion and the second main portion are vertically opposite to each other, and the first protruding portion and the second protruding portion are opposite to each other left and right in a staggered manner;
wherein there is defined a plurality of first probe storage holes in a side of the first main portion opposite to the second main portion, and a plurality of second probe storage holes in a side, of the first protruding portion opposite to the second protruding portion;
wherein there is defined a plurality of third probe storage holes in a side of the second main portion opposite to the first main portion, and a plurality of fourth probe storage holes in a side of the second protruding portion opposite to the first protruding portion; and
wherein the first probe storage holes, the second probe storage holes, the third probe storage holes, and the fourth probe storage holes are each used for accommodating an acoustic emission probe.

2. The acoustic emission probe positioning system of claim 1, wherein when the first test block and the second test block are used, projections of the plurality of first probe storage holes and the plurality of third probe storage holes in an X-axis direction do not overlap, and projections of the plurality of second probe storage holes and the plurality of fourth probe storage holes in a Y-direction do not overlap.

3. The acoustic emission probe positioning system of claim 1, wherein there is defined a number of four of the first probe storage hole in the first main portion and the four first probe storage holes are distributed in the first main portion in a parallelogram shape.

4. The acoustic emission probe positioning system of claim 1, wherein two second probe storage holes are formed in the first protruding portion, and there is a height difference in a vertical direction and a distance difference in a horizontal direction between the two second probe storage holes in the first protruding portion.

5. The acoustic emission probe positioning system of claim 1, wherein an upper side of the first protruding portion and a lower side of the second protruding portion are located on a same horizontal plane.

6. The acoustic emission probe positioning system of claim 1, wherein elastic components and connecting gaskets are arranged in the first probe storage holes, the second probe storage holes, the third probe storage holes and the fourth probe storage holes respectively, the elastic components are connected to the connecting gaskets, and the connecting gaskets are connected to the acoustic emission probes.

7. The acoustic emission probe positioning system of claim 1, wherein the first probe storage holes, the second probe storage holes, the third probe storage holes and the fourth probe storage holes are communicated with wiring ducts which are used for connecting wires, connected to the acoustic emission probes, to an amplifier outside the test blocks.

8. A test block for an acoustic emission probe positioning system, comprising a main portion and a protruding part which are connected to each other, wherein a plurality of first probe storage holes are defined in the main portion, a plurality of second probe storage holes are defined in the protruding part, and the first probe storage holes and the second probe storage holes are each used for accommodating an acoustic emission probe; and projections of the plurality of first probe storage holes in an X-axis direction do not overlap, and projections of the second probe storage holes in a Y-axis direction do not overlap.

9. An application of an acoustic emission probe positioning system, wherein the acoustic emission probe positioning system of claim 1 is applied to a direct shear test and/or a uniaxial compression test.
